(19) United States
(12) Patent Application Publication
(10) Pub. No.: US 2024/0370496 A1
(43) Pub. Date: Nov. 7, 2024

(54) TEMPLATE-BASED STORAGE AND MANAGEMENT OF DATA MODELS IN A GRAPH DATABASE

(71) Applicant: SYNTES, INC., Bethesda, MD (US)

(72) Inventors: Anatoliy Tishin, Bethesda, MD (US); Andrei LAVROV, Bethesda, MD (US)

(21) Appl. No.: 18/652,617

(22) Filed: May 1, 2024

Related U.S. Application Data
(60) Provisional application No. 63/499,370, filed on May 1, 2023.

(51) Int. Cl. G06F 16/901; G06F 16/906

(52) U.S. Cl. CPC G06F 16/9024; G06F 16/906

(57) ABSTRACT

A method for generating a graph database includes defining plural templates of the graph database, each of the templates corresponding to a respective object category. Each of the templates includes nodes defining identifying attributes of an object in the object category. The method further includes selecting a first template to represent a first object corresponding to the object category of the first template and selecting a second template to represent a second object corresponding to the object category of the second template. The method further includes linking the first template to the second template by storing relationship data between a node of the first template and a node of the second template, and populating the first template and the second template by parsing received data of the first object and the second object.

### CROSS-REFERENCE TO RELATED APPLICATIONS

This application claims priority to co-pending U.S. Provisional Application No. 63/499,370 titled “SYSTEM AND METHOD FOR CREATING TEMPLATES FOR A GRAPH DATABASE”, filed May 1, 2023, which is incorporated herein by reference in its entirety.

### FIELD OF TECHNOLOGY

The present disclosure relates to the field of applications built for graph databases, e.g., applications for electronic commerce, manufacturing, healthcare, construction, and the like.

### BACKGROUND

A data store that uses graph theory to organize data as relations between objects is known as a “graph database.” In a graph database, data items are generally represented by nodes and relationships between the data items are generally represented by links.

When a graph database includes nodes and links without a structure that represents a predefined data model, it is referred to as an unstructured graph. Creating objects for new and existing applications using unstructured graphs requires accessing nodes and links individually—making the process repetitive and time consuming.

Therefore, there is a need for a method and a system for improving and optimizing object creation for graph databases.

### SUMMARY

Aspects of the disclosure relate to creating templates for graph databases. The method of the present disclosure improves the process of creation of objects for applications.

In an aspect, a method for using templates to generate data in a graph database includes defining plural templates of the graph database, each of the plural templates corresponding to a respective object category in a process. Each of the plural templates including nodes includes (i) an anchor node defining identifying attributes of an object in the object category and (ii) N other nodes linked to the anchor node and respectively defining descriptive attributes of the object in the object category, N being a non-negative integer. The method further includes selecting a first template of the plural templates to represent a first object corresponding to the object category of the first template and selecting a second template of the plural templates to represent a second object corresponding to the object category of the second template. The method further includes linking the first template of the plural templates to the second template of the plural templates by storing relationship data between a node of the first template and a node of the second template, and populating the first template and the second template by parsing received data of the first object and the second object.

In an aspect, a system for using templates to generate data in a graph database includes at least one processor configured to define plural templates of the graph database, each of the plural templates corresponding to a respective object category in a process. Each of the plural templates including nodes includes (i) an anchor node defining identifying attributes of an object in the object category and (ii) N other nodes linked to the anchor node and respectively defining descriptive attributes of the object in the object category, N being a non-negative integer. The at least one processor is further configured to select a first template of the plural templates to represent a first object corresponding to the object category of the first template and select a second template of the plural templates to represent a second object corresponding to the object category of the second template. The at least one processor is further configured to link the first template of the plural templates to the second template of the plural templates by storing relationship data between a node of the first template and a node of the second template, and populate the first template and the second template by parsing received data of the first object and the second object.

In an aspect, a non-transitory computer readable medium storing thereon computer executable instructions for using templates to generate data in a graph database, including instructions for defining plural templates of the graph database, each of the plural templates corresponding to a respective object category in a process. Each of the plural templates including nodes includes (i) an anchor node defining identifying attributes of an object in the object category and (ii) N other nodes linked to the anchor node and respectively defining descriptive attributes of the object in the object category, N being a non-negative integer. The method further includes selecting a first template of the plural templates to represent a first object corresponding to the object category of the first template and selecting a second template of the plural templates to represent a second object corresponding to the object category of the second template. The method further includes linking the first template of the plural templates to the second template of the plural templates by storing relationship data between a node of the first template and a node of the second template, and populating the first template and the second template by parsing received data of the first object and the second object.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 illustrates a block diagram of creating templates for a graph database for a product information and electronic commerce.

FIG. 2 illustrates a block diagram of creating templates for a graph database for a quality control and quality assurance.

FIG. 3 illustrates a method for creating templates for a graph database in accordance with aspects of the present disclosure.

FIG. 4 illustrates a method for generating a graph database in accordance with aspects of the present disclosure.

FIG. 5 illustrates a block diagram of selecting sub-templates when a selected template is associated with multiple sub-templates.

FIG. 6 presents a representative diagram of an example of various components and features of a general purpose computer system usable or incorporable with various features in accordance with aspects of the present disclosure.

FIG. 7 is a block diagram of various example system components, usable in accordance with aspects of the present disclosure.

### DETAILED DESCRIPTION

Aspects of the disclosure are described herein in the context of a system, method, and a computer program for creating templates for graph databases in accordance with aspects of the present disclosure. Those of ordinary skill in the art will realize that the following description is illustrative only and is not intended to be in any way limiting. Other aspects will readily suggest themselves to those skilled in the art having the benefit of the disclosure. Reference will now be made in detail to implementations of the example aspects as illustrated in the accompanying drawings. The same reference indicators will be used to the extent possible throughout the drawings and the following description to refer to the same or like items.

In order to describe the teachings of the present disclosure with clarity, a brief summary list of terms used throughout the disclosure is first provided below.

A graph structure for a graph database provides a mechanism for grouping nodes and enables a hierarchical representation of the nodes (or groups of nodes) and links. Then attributes may be defined for the nodes and links. Content may be populated into those attributes. The attributes of a node may include items such as the name of the node, the description of the object the node represents, identification, and the like. The attributes of the link may include items such as order, value representing relationship, and the like.

An object refers to an object that is involved in a specific process. For example, for electronic commerce, objects may be created for the following: product category, product bundle, customer entity, product order, product cards for various products within the product category/bundle, and the like.

The method of the present disclosure creates templates for a graph database of any complexity by creating templates for objects that are involved in operations of a process. Then, operations may be performed on the templated objects.

When objects are created for a process, e.g., for a product category, product bundle, customer entity, product order, product card, and so on, a section (interchangeably referred to herein as a “portion”) of the graph may be created. The newly created portion of the graph may then be connected to the rest of the graph. The graph that includes all the relevant portions may be used for the process in a unified manner.

The object may be formed from multiple portions of a graph. Each portion of the graph may include several nodes and links among the several nodes. Attributes are defined for each of the nodes and links of the object. The attributes of the nodes and links are then populated with data values.

A product description may be provided, including a main graph node for the product, general attributes of the product, and any number of other graph nodes that are linked to the main graph node along with respective attributes of the graph nodes and links.

The present disclosure describes a method and system for using templates to generate a graph database. For a given process, applications may need to be created to support workflows of the process. The applications may be supported using a data model. For instance, for retail, an application may be needed for an ordering process, order fulfillment process, and so on. Thus, a data model that may be used for all the applications of the process may be identified.

Then, for each application, the method may create templates corresponding to object categories to be included in the data model. For example, a template may be created for customer information, and another template may be created for order information.

The method may define a repeatable graph data structure for each template. For instance, the template for customer information may include a repeatable graph data structure with fields to be used for customer identification, customer name, demographic data, etc. The repeatable graph data structure of the template may include at least one anchor node and any number of other nodes linked to the anchor node. The anchor and other nodes of the template form a group that may be used to represent objects belonging to the object category of the template. Nodes within a template are internal nodes. In contrast, if a node is formed for another template of the data model, the node is referred to as an external node. For each template, the method may define attributes of the anchor node(s) and any number of other nodes.

The method may represent relationships between the templates using links and define attributes for the links. For example, links may be created between anchor nodes of different templates to represent relationships between the object categories of the templates. When input data is received for the process, templates may be instantiated to represent objects in the input data that fall into the various object categories and the attributes of the instantiated templates may be populated with the received data. For example, The method of the present disclosure is illustrated by way of the following examples.

### Example One

Assuming it is desirable to create an application for product information and conducting electronic commerce, a determination must be made on applications needed for conducting the electronic commerce. The applications may be supported using a data model which describes entities such as: products, product categories, product bundles, orders by customers, and so on. The entities may be grouped and/or linked to other entities.

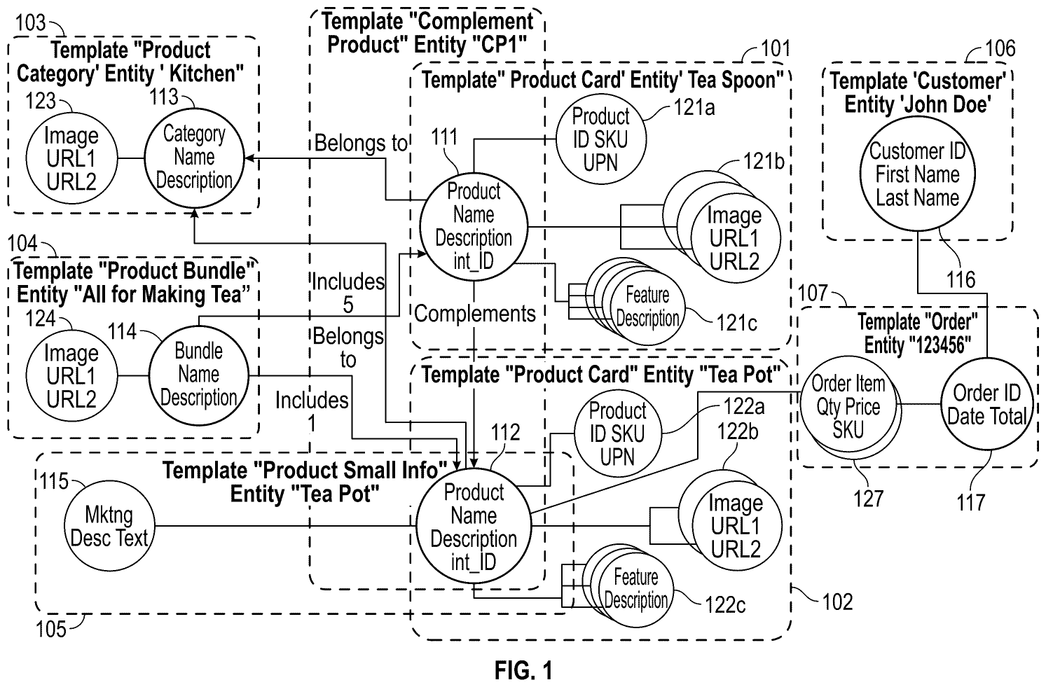

FIG. 1 illustrates a block diagram of templates for a graph database representing product information and electronic commerce. There are two types of processes illustrated in this example. The first process is related to product information management and the second process is related to order management (i.e., customer facing). The two processes share the graph database. Two applications may be created, one for product information management and one for order management. It is noted that other applications may be added as needed, for instance order fulfillment may be in another process for which a third application may be created.

Object categories for the ecommerce may be created for the following:
product,
product category,
product bundle,
product marketing information (e.g., thumbnails for marketing purposes),
customer,
order,
complementary product,
and the like.

For each of the above object categories, a template may then be created. For ease of understanding, illustrative examples of creating templates for the object categories listed above are herein described.

For the object category titled “product”, a product template may be created. The product template includes an anchor node and any number of other nodes linked to the anchor node. The anchor node and the other nodes created for the product object category are grouped together. For example, the anchor node and the other nodes created for the product template may be grouped together. For clarity, nodes which are created for a particular object category may also be referred to as internal nodes. That means if a node is outside of the group established for the particular object category, it may be referred to as an external node.

In one aspect, the other nodes of the product template may include: a first node for identifiers of the product, a second node for product images/photos of the product, a third node for a feature description of the product (e.g., specification), and so on.

Then attributes may be defined for the anchor node. The attributes of the anchor node may include items such as the name of the product, the description of the product, product identification, and the like.

In one aspect, the first node is used for identifiers such as SKU (stock-keeping unit), UPN (universal product number), among other identifiers of the product. In one aspect, the second node is used for product images and/or universal resource locators (URLs) to product images. In one aspect, the third node is for feature descriptions of the product and/or URLs to a server at which the specifications for the product are located.

For the object category titled “product category”, a product category template may be created. The product category template includes an anchor node and any number of other nodes linked to the anchor node. In one aspect, the other nodes of the product category template may include any number of nodes, for example for category images. Then, for the anchor node of the product category template, attributes may be defined. The attributes of the anchor node of the product category may include items such as a description of the product category, and the like.

For the object category titled “product bundle”, a product bundle template may be created. The product bundle template includes an anchor node and any number of other nodes linked to the anchor node. In one aspect, the other nodes of the product bundle template may include any number of nodes, for example for bundle images. Then, for the anchor node of the product bundle template, attributes may be defined. The attributes of the anchor node of the product bundle may include items such as a description of the product bundle, and the like.

For the object category titled “product marketing information”, a product marketing information template may be created. The product marketing information template includes an anchor node and any number of other nodes linked to the anchor node. Then, for the anchor node of the product marketing information template, attributes may be defined. The attributes of the anchor node of the product category may include items such as a description of the product marketing information to be used for marketing purposes. In one aspect, the other nodes of the product small information template may include any number of nodes for various target markets, e.g., wholesale, retail, and the like. For the example shown in FIG. 1, the template for the product marketing information includes just the anchor node.

For the object category titled “customer”, a “customer” template may be created. The customer template may include an anchor node and any number other nodes linked to the anchor node. Then, for the anchor node of the customer template, attributes may be defined. The attributes of the anchor node of the customer template may include items such as customer identification, customer first name, customer last name, among other identifiers of the customer. In some scenarios, the other nodes of the customer template may be used for other descriptions, such as for customer order history.

For the object category titled “order”, an “order” template may be created. The order template may include an anchor node and any number other nodes linked to the anchor node. Then, for the anchor node of the order template, attributes may be defined. The attributes of the anchor node of the order template may include items such as order number, date, total amount of order, among other attributes. The other nodes of the order template may be used for order items, quantities, prices, SKUs, among other features. The order items may be linked to product objects in a product information application, e.g., to enable a user to obtain more information about the product.

For the object category titled “complementary product,” a “complementary product” template may be created. The complementary product template may include a combination of anchor nodes of different products. For example, in FIG. 1, the complementary product template includes the anchor nodes for “teapot” and “teaspoon”. In other words, the complementary product template may have its own anchor node or use the anchor nodes of other templates. In another approach for creating templates for complementary products, a template may be created for the complementary products by creating a link in a product template that points to the same template, i.e., to itself. The link to the same template may be named “complements.” Multiple complementary products may then be linked to each other via the link defined in the product template. Thus, for the example of FIG. 1, the “teapot” and “teaspoon” instances of the product template may be linked to each other.

Once all of the above templates are created for the various objects categories, relationships between the templates may be represented using links. For example, links may be created between a particular instance of a product template and a particular instance of a product category template. Similarly, links may be created between a particular instance of a product template and a particular instance of a product bundle template. In addition, a particular instance of a product may be linked to any number of other products, such as products of the same type, products having similar templates, and the like. The links between the particular product and other products are named based on the relationship to the particular product. For example, a link to products cheaper than the particular product may be named “cheaper than”, a link to a complementary product may be named “complements”, and so on. Thus, the template for a product may define any number of links that point to other instances of the same template. However, these links that point to other instances of the same template have distinct labels and are between different objects defined by the template.

The method of the present disclosure for creating templates for a graph database comprises: defining objects, each object serving a specific purpose for a process that uses a graph database; for each object, identifying a repeatable graph data structure; for each object, defining the graph data structure of the repeatable graph data structure using a respective template, the respective template defining an anchor node and any number of other nodes linked to the anchor node; defining attributes of the anchor node, the any number of other nodes, and the links; representing relationships between the templates using the links; receiving actual data for the process, and populating the attributes of the anchor node, the any number of other nodes, and the links with the received actual data.

An aspect of the present disclosure includes generating a graph database by defining plural templates of the graph database, each of the plural templates corresponding to a respective object category in a process. Each of the one or more templates include nodes including (i) an anchor node defining identifying attributes of an object in the object category and (ii) N other nodes linked to the anchor node and respectively defining descriptive attributes of the object in the object category, where N is a non-negative integer. The method further includes selecting a first template of the plural templates to represent a first object corresponding to the object category of the first template and selecting a second template of the plural templates to represent a second object corresponding to the object category of the second template. The method also includes linking the first template of the plural templates to the second template of the plural templates by storing relationship data between a node of the first template and a node of the second template. Finally, the method includes populating the first template and the second template by parsing received data of the first object and the second object.

For example, in order to add a new product to a graph database, the template for the product category may be instantiated to add information about the new product into the graph database. Then, links may be used to relate the new product to any other objects, such as bundles or categories to which the new product belongs. Similarly, in order to create a new application, some of the already created templates may be instantiated and some other new templates may be created. Then, links may be used to represent relationships among the new and previously created templates.

Returning to FIG. 1, templates may be created for products, product category, product bundle, product marketing information, customer, and order. For each template, the method may identify a repeatable graph data structure, define the graph data structure using an anchor node and any number of other nodes linked to the anchor node, and define attributes of the anchor node, the any number of other nodes, and the links. Then, the method may represent relationships between the templates using the links. When attribute data is received, the attributes of the anchor node, the any number of other nodes, and the links may be populated. Thus, content is populated into the various attributes of the anchor node, the other nodes, and the links.

For the illustrative example of FIG. 1, the received data includes the products: teaspoon and teapot. Thus, the product template 101 is used to create nodes, links between nodes, and define attributes of the nodes and links for the entity “teaspoon” and the product template 102 may be used to create nodes, links between nodes, and define attributes of the nodes and links for the entity “teapot”. The product template 101 is used to create nodes 111 and 121a-121c. Nodes 121-121c may then be linked to anchor node 111. The product template 102 is used to create nodes 112 and 122a-122c. Nodes 122a-122c may be linked to anchor node 112. The values of the attributes of nodes and links for the respective two products may be populated using the received data (content). Similarly, the template 103 may be used to create nodes 113 and 123 for entity “kitchen”, the template 104 may be used to create nodes 114 and 124 for the entity (bundle) “all products for making tea”. The template 105 may be used to create nodes for “product small information”, which is this case includes only one node 115. In one example, attributes of node 115 may contain for marketing description text. The customer template 106 may be used to create anchor node 116. Attributes of the anchor node 116 may be populated to contain customer IDs and names. The order template 107 may be used to create an anchor node 117 and another node 127. The attributes of the anchor node 117 may be used for containing order ID, date, total. Similarly, attributes of the another node 127 may be used for storing order items, quantity, price, and SKUs. Then, based on the data and relationships between the various nodes, the links may be formed among the nodes.

### Example Two

Assuming it is desirable to create an application for quality control and quality assurance, first, a determination must be made with regard to a data model that describes the quality control and quality assurance process. For example, the process may include inspection. Then, an application for supporting inspections for quality control and quality assurance may be created. The inspection application may need to consider a data model that describes locations, types of inspections, lists of inspectors, contractors, inspection results, among other things.

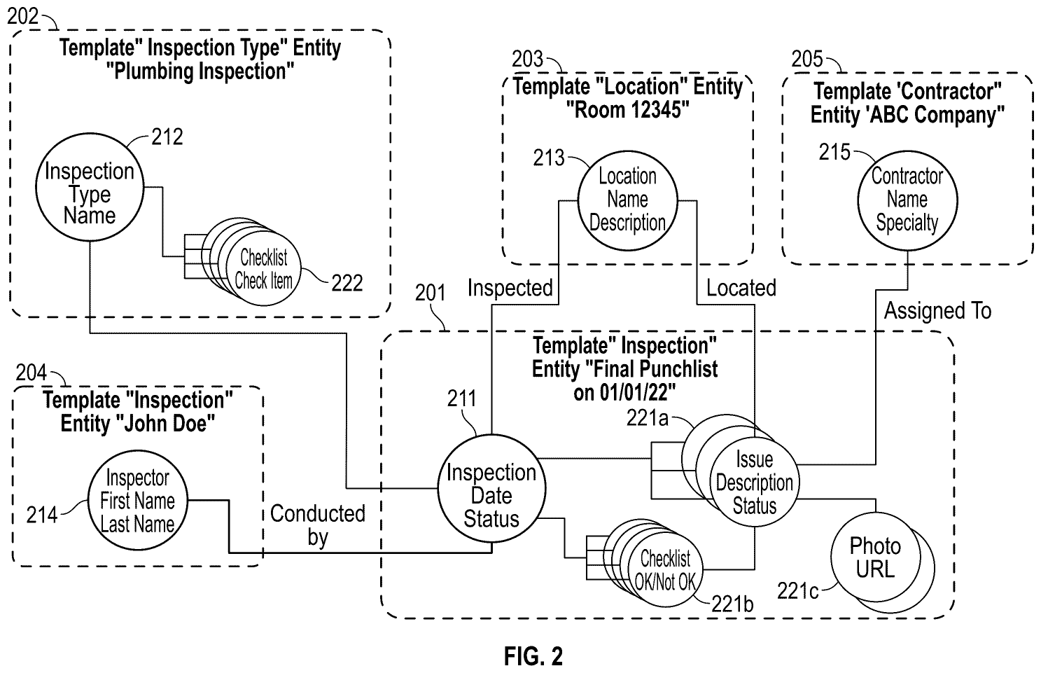

FIG. 2 illustrates a block diagram of creating templates for a graph database for a quality control and quality assurance.

Template may be created for inspection, inspection type, location, inspector, and contractor. For each template, the method may then identify a repeatable graph data structure, define the graph data structure using a respective template that includes an anchor node and any number of other nodes linked to the anchor node, and define attributes of the anchor node, the any number of other nodes, and the links. Then, the relationships between the templates may be represented using the links. When an actual data is received, the attributes of the anchor node, the any number of other nodes, and the links may be populated.

For the illustrative example of FIG. 2, the actual data is for a final punch-list. Thus, inspection template 201 may be used to create anchor node 211 and other nodes 221a-221c for the entity “final punch-list”. Nodes 221-221c may then be linked to the anchor node 211. Then, attributes are defined for the anchor node 211, the other nodes 221a-221c, and the links between the nodes. The attributes for the final punch-list may be populated with respective values. The template 202 may be used to create nodes 212 and 222 for entity “plumbing inspection”, the template 203 may be used to create node 213 for the entity “room 12345”, the template 204 may be used to create node 214 for the entity “Inspector Name” (John Doe, for example), and the template 205 may be used to create node 215 for contractor information, such as name and specialty. Then, based on the data and relationships between the various nodes of FIG. 2, the links may be formed among the nodes.

### Example Three

Assuming it is desirable to create a template called “patent” first, a determination must be made if there is an existing template for patent. If there is an existing template, one of the available templates may be selected. If not, a new template may be created.

Next, the attributes for the template called patent may be defined. For instance, the attributes may include: a title in a form of strings, description in a form of HTML text, and an image file (e.g., for a predetermined number of diagrams), among other attributes. Groups may then be created, if needed. For example, an internal node for additional diagrams may be created.

Assuming it is desirable to create another object for claims, a template for claims may be created and attributes for the template called claims may be defined. For instance, the attributes may include: a minimum number of claims (e.g., one), a maximum number of claims (e.g., infinite), and the like.

Then, once completed, the graph for the template called “patent” may include one main node (anchor node) of the patent and main nodes of claims, which are created based on two separate templates (one being for the patent, the other being for the claims). The main node for the patent and the main nodes of each claim have links between them. Thus, the templates are used to create the nodes, links, and attributes.

The above approach may be used to create templates for a graph database without the need for coding. Thus, the present disclosure discloses a data model that enables organization of the data without extensive programming knowledge. The model enables creation of applications and templates within each of the applications. The templates may then be used for future data to create nodes, links, and attributes. That is, once the data model is built, the model may be populated with actual data by assigning values to the attributes of the nodes and links.

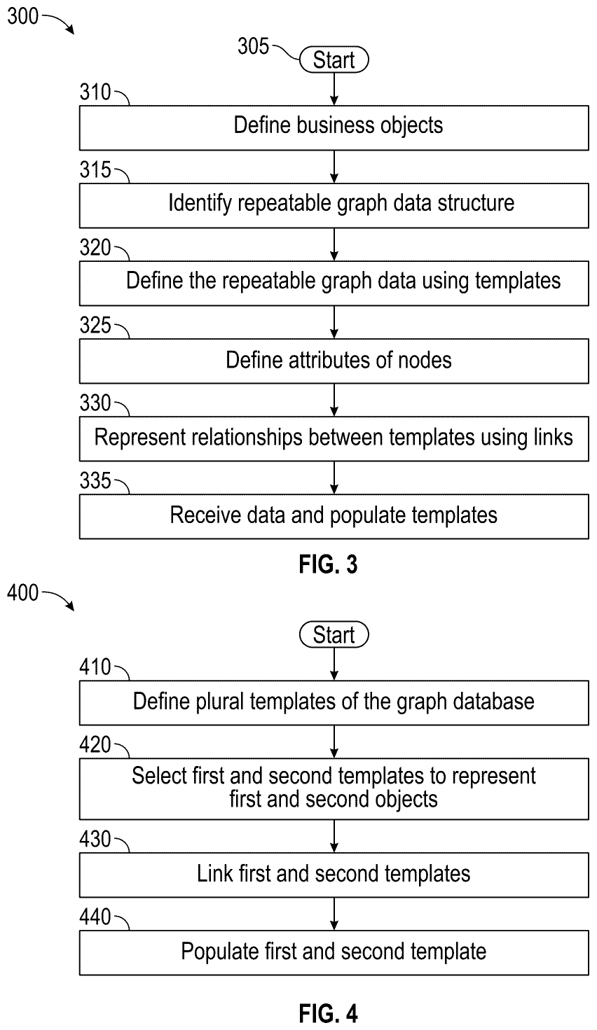

FIG. 3 illustrates a method 300 for creating templates for a graph database in accordance with aspects of the present disclosure. Method 300 starts in step 305 and proceeds to step 310.

In step 310, method 300 defines objects, each object serving a specific purpose for a process that uses a graph database.

In step 315, for each object, method 300 identifies a repeatable graph data structure.

In step 320, for each object, method 300 defines the graph data structure of the repeatable graph data structure using a respective template, the respective template defining an anchor node, any number of other nodes linked to the anchor node, and links among the anchor node and the any number of other nodes.

In step 325, method 300 defines attributes of the anchor node, the any number of other nodes, and the links.

In step 330, method 300 represents relationships between the templates using the links.

In step 335, method 300 receives actual data for the process and populates the attributes of the anchor node, the any number of other nodes, and the links with the received actual data.

In one example, the objects comprise at least one of: an object for a product, an object for a product category, an object for a product bundle, an object for product small information, an object for customer information, an object for order information, an object for complementary product information. In one example, the template for at least one object comprises a combination of anchor nodes of different objects. In one example, attributes of a node include at least one of: a name of the node, a description of the object the node represents, and identification of the node. In one example, attributes of a link include at least a value or order.

FIG. 4 shows a method for generating a graph database in accordance with aspects of the present disclosure. The method starts at step 410 when at least two templates are defined for use in a graph database. As described above, each template corresponds to an object category, for example product, customer, location, inspection, or patent. When instantiated and populated, each of the defined templates will represent one object in the corresponding category—for example, a particular product, a particular customer, a particular location, a particular inspection, or a particular patent.

Accordingly, at step 420, two templates are selected that correspond to object categories of two objects to be included in the graph database. For example, the first object may be a product and the second object may be a customer. In this case, a product template may be selected for the first object and a customer template may be selected for the second object in step 420.

At step 430, the selected templates are linked to represent a relationship between the first and second objects. For example, the selected product template may be linked to the selected customer template to represent a purchase or order by a customer of a product. While steps 420 and 430 describe selecting and linking two templates, these steps may be performed iteratively to select and link additional templates in order to configure the structure of the graph database.

Upon completion of the selection and linking of all templates, a data structure is generated that represents objects and relationships, including attributes thereof, that will be described in incoming data. Once the incoming data is received, the attributes of the templates in the data structure may be populated with values from the incoming data. That is, attributes in the first and second template that were selected and linked in steps 420 and 430 may be populated in step 440 using information in the incoming data.

The links created between templates may have attributes that describe the relationships between the linked templates. Some examples of such link attributes or relationships between two templates include “belongs to” (i.e., object represented by one template belongs to object represented by another template), “includes” (i.e., object represented by one template includes object represented by another template), “complements” (i.e., object represented by one template complements object represented by another template), “is conducted by” (i.e., object represented by one template is conducted by object represented by another template), “is located in” (i.e., object represented by one template is located in object represented by another template), and “assigned to” (i.e., object represented by one template is assigned to object represented by another template), Other relationships may also be described by the link attribute between two templates.

In one aspect, the system described in the present disclosure is to be integrated with an external system to define the templates and/or populate the graph database. In this aspect, application programming interface (API) documentation of the external system may be provided to the present system for implementing integration with the external system. For example, Graph QL or RESTful APIs may be provided to support such integration.

The provided API documentation may be used by the present system to generate templates and links therebetween, along with appropriate attribute fields, to create the structure of the graph database. Furthermore, the present system may use the provided API documentation to automate synchronization of data between the external system and the graph database by populating the graph database using the available API functions.

In an aspect, one or more of the defined templates of the graph database are associated with a display configuration that defines display positions of attributes associated with the template. For example, instead of displaying the attributes of a template in list form, hierarchically or alphabetically, the display configuration may define that certain attributes are displayed side-by-side and/or in a more prominent display location to increase user convenience when viewing, editing, or populating the templates.

In an aspect, certain attributes of a template may be configured to include two or more values that are associated with each other. For example, a first value may be numerical while the second is a measurement or monetary unit associated with the first value. Other combinations of two or more attribute values may be included in the templates of the present disclosure.

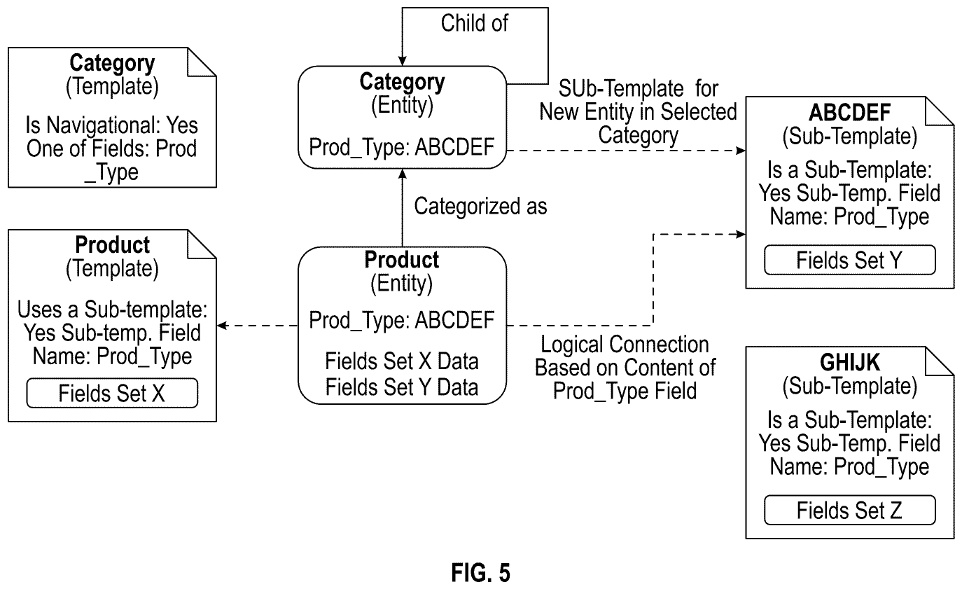

FIG. 5 shows a block data structure showing the use of sub-templates. On the left hand side of FIG. 5, a category template and a product template are shown. These templates are instantiated to represent a particular product and its corresponding category in the blocks labeled respectively “Product (Entity)” and “Category (Entity).”

As shown in FIG. 5, the instantiated product template is linked to the instantiated category template with a link having an attribute of “characterized as.” This link represents the relationship of the product represented by the product template being categorized as a category represented by the category template.

FIG. 5 further shows that the product template is associated with two sub-templates shown on the right hand side of FIG. 5: a sub-template named ABCDEF and a sub-template named GHIJK. Accordingly, when the product template is instantiated, one of the sub-templates may be selected to define the specific set of attributes to be included in the template. That is, each of the available sub-templates define a different set of attributes that allow for variations to the product template. In the example of FIG. 5, sub-template ABCDEF is selected among the sub-templates available for the product template based on the content of a prod_type field.

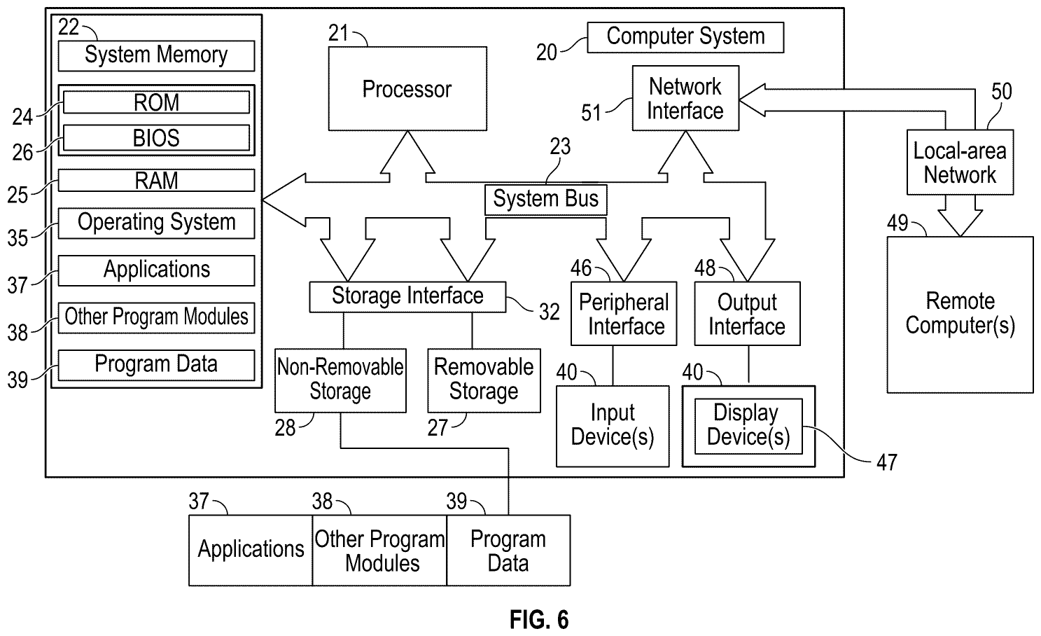

FIG. 6 is a block diagram illustrating various components of an example computer system 20 via which aspects of the present disclosure for enrolling patients into clinical trials may be implemented. The computer system 20 may, for example, be or include a computing system of the user device, or may comprise a separate computing device communicatively coupled to the user device, etc. In addition, the computer system 20 may be in the form of multiple computing devices, or in the form of a single computing device, including, for example, a mobile computing device, a cellular telephone, a smart phone, a desktop computer, a notebook computer, a laptop computer, a tablet computer, a server, a mainframe, an embedded device, and other forms of computing devices.

As shown in FIG. 6, the computer system 20 may include one or more central processing units (CPUs) 21, a system memory 22, and a system bus 23 connecting the various system components, including the memory associated with the central processing unit 21. The system bus 23 may comprise a bus memory or bus memory controller, a peripheral bus, and a local bus that is able to interact with any other bus architecture. Examples of the buses may include PCI, ISA, PCI-Express, HyperTransport™, InfiniBand™, Serial ATA, I2C, and other suitable interconnects. The central processing unit 21 (also referred to as a processor) may include a single or multiple sets of processors having single or multiple cores. The processor 21 may execute one or more computer-executable lines of code implementing techniques in accordance with aspects of the present disclosure. The system memory 22 may be or include any non-transitory computer-readable medium for storing data used herein and/or computer programs that are executable via the processor 21. The system memory 22 may include volatile memory, such as a random access memory (RAM) 25 and non-volatile memory, such as a read only memory (ROM) 24, flash memory, etc., or any combination thereof. The basic input/output system (BIOS) 26 may store the basic procedures for transfer of information among elements of the computer system 20, such as those at the time of loading the operating system with the use of the ROM 24.

The computer system 20 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory such as cache, SRAM, DRAM, zero capacitor RAM, twin transistor RAM, eDRAM, EDO RAM, DDR RAM, EEPROM, NRAM, RRAM, SONOS, PRAM; flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which can be accessed by the computer system 20.

The system memory 22, removable storage devices 27, and non-removable storage devices 28 of the computer system 20 may be used to store an operating system 35, additional program applications 37, other program modules 38, and program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 20 may be equipped with other peripheral output devices (not shown), such as loudspeakers and other audiovisual devices.

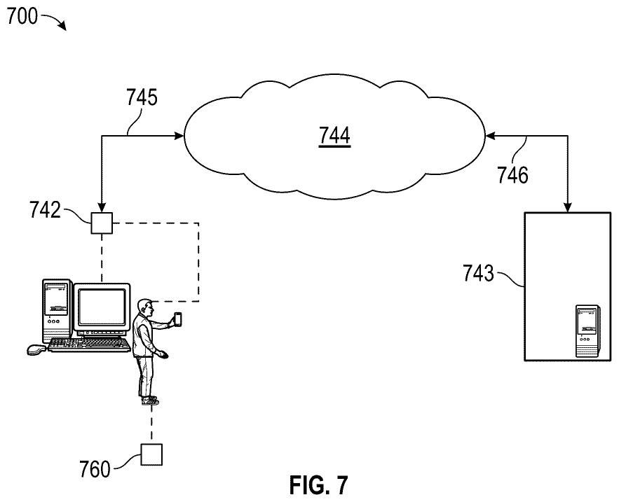

The computer system 20 may operate in a network environment as shown in FIG. 7, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces.

FIG. 7 shows a communication system 500 usable in accordance with aspects of the present disclosure. The communication system 500 includes one or more accessors 560 (also referred to interchangeably herein as one or more “users”) and one or more terminals 542. In one aspect, data for use in accordance with aspects of the present disclosure may, for example, be input and/or accessed by accessors 560 via terminals 542, such as personal computers (PCs), minicomputers, mainframe computers, microcomputers, telephonic devices, or wireless devices, such as personal digital assistants (“PDAs”), smart phones, or other hand-held wireless devices coupled to a server 543, such as a PC, minicomputer, mainframe computer, microcomputer, or other device having a processor and a repository for data and/or connection to a repository for data, via, for example, a network 544, such as the Internet or an intranet, and couplings 545, 546. In one aspect, various features of the method may be performed in accordance with a command received from another device via a coupling 545, 546. The couplings 545, 546 may include, for example, wired, wireless, or fiberoptic links. In another variation, various features of the method and system in accordance with aspects of the present disclosure may operate in a cloud network environment using Software as a Service (SaaS). For example, an internet browser running on a terminal 542 is used to interface with a program running in hosting facility which may contain any number of servers. These servers run a cloud operating environment, which in turn executes codes of the program of the present method and system. In another variation, various features of the method and system in accordance with aspects of the present disclosure may operate in a stand-alone environment, such as on a single terminal. In one aspect, the server 543 may be a remote computer 49, as shown in FIG. 6, or a local server.

Aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store program code in the form of instructions or data structures that can be accessed by a processor of a computing device, such as the computing system 20. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein can be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some aspects, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various aspects, the systems and methods described in the present disclosure can be addressed in terms of modules. The term “module” as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module's functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system (such as the one described in greater detail in FIG. 6, above). Accordingly, each module may be realized in a variety of suitable configurations and should not be limited to any particular implementation exemplified herein.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of those skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

1. A method for using templates to generate data in a graph database, the method comprising:
defining plural templates of the graph database, each of the plural templates corresponding to a respective object category in a process, wherein
each of the plural templates including nodes comprising (i) an anchor node defining identifying attributes of an object in the object category of the respective template and (ii) N other nodes linked to the anchor node and respectively defining descriptive attributes of the object in the object category of the respective template, N being a non-negative integer;
selecting a first template of the plural templates to represent a first object corresponding to the object category of the first template and selecting a second template of the plural templates to represent a second object corresponding to the object category of the second template;
linking the first template of the plural templates to the second template of the plural templates by storing relationship data between a node of the first template and a node of the second template; and
populating the first template and the second template by parsing received data of the first object and the second object.

2. The method of claim 1, wherein the objects comprise at least one of: a product, a product category, a product bundle, product marketing information, customer information, order information, and complementary product information.

3. The method of claim 1, wherein at least one of the plural templates comprises plural anchor nodes of different objects.

4. The method of claim 1, wherein attributes of a node include at least one of: a name of the node, a description of the object the node represents, and identification of the node.

5. The method of claim 1, wherein the relationship data of the link between the first template and the second template comprises at least one of: the first object belongs to the second object, the first object includes the second object, the first object complements the second object, the first object is conducted by the second object, the first object is located in the second object, or the first object is assigned to the second object.

6. The method of claim 1, wherein the method further comprises:
receiving an application programming interface (API) documentation and defining the plural templates based on the API document; and
using the API to populate the graph database.

7. The method of claim 1, wherein
the first template comprises plural sub-templates, each of the sub-templates (i) defining a different configuration of one or more anchor nodes and other nodes or (ii) defining different attributes corresponding to each node, and
the selecting the first template comprises selecting one of the sub-templates of the first template to represent the first object.

8. The method of claim 1, further comprising:
defining a display configuration associated with each one of the plural templates, wherein the display configuration of a respective template defines display positions of attributes associated with nodes of the respective template; and
displaying at least one of the first template and the second template according to corresponding display configurations.

9. The method of claim 1, wherein at least one of the attributes of the first template comprises plural data fields.

10. A system for using templates to generate data in a graph database, comprising:
at least one processor configured to:
define plural templates of the graph database, each of the plural templates corresponding to a respective object category in a process, wherein
each of the plural templates including nodes comprising (i) an anchor node defining identifying attributes of an object in the object category of the respective template and (ii) N other nodes linked to the anchor node and respectively defining descriptive attributes of the object in the object category of the respective template, N being a non-negative integer;
select a first template of the plural templates to represent a first object corresponding to the object category of the first template and select a second template of the plural templates to represent a second object corresponding to the object category of the second template;
link the first template of the plural templates to the second template of the plural templates by storing relationship data between a node of the first template and a node of the second template; and
populate the first template and the second template by parsing received data of the first object and the second object.

11. The system of claim 10, wherein the objects comprise at least one of: a product, a product category, a product bundle, product marketing information, customer information, order information, and complementary product information.

12. The system of claim 10, wherein at least one of the plural templates comprises plural anchor nodes of different objects.

13. The system of claim 10, wherein attributes of a node include at least one of: a name of the node, a description of the object the node represents, and identification of the node.

14. The system of claim 10, wherein the relationship data of the link between the first template and the second template comprises at least one of: the first object belongs to the second object, the first object includes the second object, the first object complements the second object, the first object is conducted by the second object, the first object is located in the second object, or the first object is assigned to the second object.

15. The system of claim 10, wherein the at least one processor is further configured to:
receive an application programming interface (API) documentation and defining the plural templates based on the API documentation; and
use the API to populate the graph database.

16. The system of claim 10, wherein
the first template comprises plural sub-templates, each of the sub-templates (i) defining a different configuration of one or more anchor nodes and other nodes or (ii) defining different attributes corresponding to each node, and
the at least one processor is further configured to select one of the sub-templates of the first template to represent the first object.

17. The system of claim 10, wherein the at least one processor is further configured to:
define a display configuration associated with each one of the plural templates, wherein the display configuration of a respective template defines display positions of attributes associated with nodes of the respective template; and
display at least one of the first template and the second template according to corresponding display configurations.

18. The system of claim 10, wherein at least one of the attributes of the first template comprises plural data fields.

19. A non-transitory computer readable medium storing thereon computer executable instructions for using templates to generate data in a graph database, including instructions for:
defining plural templates of the graph database, each of the plural templates corresponding to a respective object category in a process, wherein
each of the plural templates including nodes comprising (i) an anchor node defining identifying attributes of an object in the object category of the respective template and (ii) N other nodes linked to the anchor node and respectively defining descriptive attributes of the object in the object category of the respective template, N being a non-negative integer;
selecting a first template of the plural templates to represent a first object corresponding to the object category of the first template and selecting a second template of the plural templates to represent a second object corresponding to the object category of the second template;
linking the first template of the plural templates to the second template of the plural templates by storing relationship data between a node of the first template and a node of the second template; and
populating the first template and the second template by parsing received data of the first object and the second object.

20. The non-transitory computer readable medium of claim 19, wherein the objects comprise at least one of: a product, a product category, a product bundle, product marketing information, customer information, order information, and complementary product information.
